(19) United States
(12) Patent Application Publication
(10) Pub. No.: US 2005/0031873 A1
(43) Pub. Date: Feb. 10, 2005

(54) Method for multi-coat refinishing of substrates

(76) Inventors: Guenter Berschel, Koeln (DE); Andrew Duda, Gladbeck (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/634,333

(22) Filed: Aug. 4, 2003

(51) Int. Cl. B05D 1/36; B32B 27/00

(52) U.S. Cl. 428/411.1; 427/402; 427/407.1; 427/409

(57) ABSTRACT

Method for multi-coat refinishing of substrates comprising the following steps: A) applying a first coat of paint consisting of a solvent-based colour- and/or special-effect-imparting coating composition to a substrate precoated with a primer and/or a filler and/or further coating compositions, B) applying a second paint coat consisting of a water-based colour- and/or special-effect-imparting coating composition to the layer obtained under A) and C) applying a clear lacquer coat consisting of a transparent clear coat to the paint coat obtained under B).

### FIELD OF THE INVENTION

The invention relates to a method for multi-coat refinishing of substrates with colour- and/or special-effect-imparting water-based paints and with transparent clear lacquers. The method can be used, in particular, in vehicle refinishing.

### DESCRIPTION OF RELATED ART

Water-based paints are also being increasingly used in vehicle refinishing for ecological reasons. However, the coatings produced with water-based paints still do not have the high quality of conventional solvent-based paints in all properties. For example, it is difficult to apply water-based base coats in relatively thick layers of, for example, more than 40 μm. Layer thicknesses of more than 40 μm or 45 μm are, however, readily achieved, for example, if a plurality of spraying operations are used. This is necessary for some shades of colour that have poor hiding power. A plurality of spraying operations are also necessary if a special-effect water-based base coat pigmented with non-covering interference pigments is used which conventionally require a three-layer structure consisting of solid-color water-based base coat as background shade, special-effect water-based basecoat and clearcoat. Problem-free application of the water-based base coats is not ensured when applying layers that have a thickness of more than 40 to 45 μm, i.e. impairment of the overall structure can be observed. Thus, flow and gloss deteriorate when the water-based base coats are coated with clear lacquers and the final hardness is sometimes inadequate, as is the masking capacity. Markings remain when the paint is masked with masking tape and cannot be compensated for by the application of a clear lacquer.

There have been many attempts to eliminate or at least mitigate the deficiencies of the prior art, for example by corresponding binder developments, adapted paint formulations or modified methods of application. Thus, a method of refinishing using aqueous metallic and special-effect basecoats is described, for example, in EP-A-729 390 in which the water-based paint is applied to the prepared surface of an old finish until a limit is reached, in a first spraying process, and the surface coated in this way is then coated with the water-based base coat in a second spraying process. These method steps are then repeated, again until a limit is reached, until the entire object to be coated is provided with the basecoat layer.

A further method of refinishing by blending in is described in EP-A-719 185 in which an aqueous basecoat is applied to cover the damaged area in one spraying process and the spray gun is inclined obliquely toward the damaged area when applying the basecoat to the adjacent regions having the old finish, so the spray gun forms an angle between 25 and 65° with the surface of the old finish.

However, the methods of application known from the prior art have not been successful in satisfactorily overcoming the above-mentioned deficiencies and there is still a need for further improved methods of multi-coat refinishing which allow water-based paints to be used to reduce solvent emission, without the above-mentioned deficiencies occurring.

### SUMMARY OF THE INVENTION

The present invention relates to a method for the multi-coat refinishing of substrates with colour- and/or special-effect-imparting water-based coating compositions comprising the following steps:

A) applying a first paint coat consisting of a solvent-based colour- and/or special-effect-imparting coating composition to a substrate precoated with a primer and/or a filler and/or further coating compositions,

B) applying a second paint coat consisting of a water-based colour- and/or special-effect-imparting coating composition to the coat obtained under A) and

C) applying a clear lacquer coat consisting of a transparent clear coat to the paint coat obtained under B).

Alternatively, the present invention also relates to a method for the multi-coat refinishing of substrates with colour- and/or special-effect-imparting water-based coating compositions comprising the following steps:

A) applying a first paint coat consisting of a water-based colour- and/or special-effect-imparting coating composition to a substrate precoated with a primer and/or a filler and/or further coating compositions,

B) applying a second paint coat consisting of a solvent-based colour- and/or special-effect-imparting coating composition to the layer obtained under A) and

C) applying a clear lacquer coat consisting of a transparent clear coat to the paint coat obtained under B).

### DETAILED DESCRIPTION OF THE EMBODIMENTS

The solvent-based and water-based colour- and/or special-effect-imparting coating compositions are preferably colour- and/or special-effect-imparting basecoats. The basecoat is therefore applied according to the invention in that firstly a solvent-based basecoat is applied and a water-based basecoat is only applied to the layer thus obtained. Alternatively, the basecoat can also be applied in that, according to the invention, a water-based basecoat is firstly applied and a solvent-based basecoat is applied to the layer thus obtained.

However, it is also possible to use a colour- and/or special-effect-imparting solvent-based two-component, one-coat topcoat instead of the solvent-based colour- and/or special-effect-imparting basecoat. However, for the sake of simplicity reference will always be made hereinafter to a solvent-based basecoat.

It has surprisingly been found that when using the method according to the invention coatings with good flow and gloss, good final hardness and hiding power as well as good adhesion between basecoat and clear lacquer are achieved. It was also surprising that solvent-based basecoats allowed over-coating with water-based basecoats without problems, for example, without wetting defects, and water-based basecoats allowed over-coating with solvent-based basecoats without problems.

The basecoats applied in the method according to the invention are conventional solvent-based or water-based basecoats of the type known to the person skilled in the art in the field of vehicle painting, in particular vehicle refinishing. The basecoats generally contain binders, colour- and/or special-effect-imparting pigments, additives and organic solvents and/or water.

The binders are conventional binders of the type used in solvent-based and water-based basecoats. Examples of binders which may be used are polyurethane, acrylated polyurethane, polyacrylate, polyester, acrylated polyester and/or alkyd resins. The binder systems can be physically dried and/or chemically crosslinked, for example by polymerization, polycondensation and/or polyaddition reactions. Chemically cross-linkable binder systems contain corresponding cross-linkable functional groups. Suitable functional groups are, for example, hydroxyl groups, isocyanate groups, acetoacetyl groups, unsaturated groups, for example, (meth)acryloyl groups, epoxide groups, carboxyl groups and amino groups. Cross-linking agents with appropriate, complementarily reactive functional groups may be provided for cross-linking. Hydroxyl group-containing binders and polyisocyanate cross-linking agents are preferred among the chemically cross-linkable binder systems.

Adequate water-diluability of the binders has to be ensured in the water-based basecoats. The water-diluability can be achieved in the manner known to the person skilled in the art by ionic and/or non-ionic modification of the binders. Anionic modification can, for example, be achieved by incorporation of carboxyl groups and at least partial neutralization thereof. Suitable neutralizing agents are basic compounds, such as, tertiary amines, for example, triethylamine, dimethylethanolamine, diethylethanolamine. A non-ionic modification can, for example, be achieved by incorporation of polyethylene oxide units. In addition to or in place of the above-mentioned possibilities, external emulsifiers can also be used to ensure the required water diluability.

Further resins, for example, cellulose esters, such as, cellulose acetobutyrate and/or melamine resins, may be provided in the coating composition.

The above-mentioned binders merely represent a list of examples. The binders can also be extensively modified and combined arbitrarily with one another. The binders which can be used are not subject to any particular restrictions. Any binders known to the person skilled in the art and binders which are conventional, in particular, in the field of vehicle painting for the formulation of colour- and/or special-effect-imparting basecoats, can be used. It is also possible, for example, to add polyisocyanates to the basecoats here without hydroxyfunctional binders being present.

The colour- and/or special-effect-imparting basecoats also contain colour pigments and/or special-effect pigments. Any pigments of an organic or inorganic nature conventional in paints are suitable as colour pigments. Examples of inorganic or organic colour pigments are titanium dioxide, micronized titanium dioxide, iron oxide pigments, carbon black, azo pigments, phthalocyanine pigments, quinacridone or perylene or pyrrolopyrrol pigments. Soluble dyes and/or transparent pigments may optionally also be provided. Examples of special-effect pigments are metal pigments, for example, consisting of aluminum or copper, interference pigments, such as metal oxide-coated metal pigments, for example, titanium dioxide-coated, iron oxide-coated or mixed oxide-coated aluminium, coated mica, such as titanium dioxide-coated mica and/or mica coated with further metal oxides, for example Fe₂O₃ and/or Cr₂O₃, platelet iron oxide and graphite pigments.

Pasty resins, for example, based on polyurethane resin or acrylate resin, can also be used in the basecoats for grinding the pigments.

The colour- and/or special-effect-imparting basecoats can also contain additives which are conventional in paints. Examples of these are flow control agents, rheology-influencing agents, such as, highly disperse silicic acid or polymer urea compounds, thickeners, such as, carboxyl group-containing polyacrylate thickeners or associative thickeners based on polyurethane, microgels, defoaming agents, wetting agents, anti-cratering agents, adhesion promoters and curing accelerators. The additives are used in the conventional quantities known to the person skilled in the art.

The colour- and/or special-effect-imparting basecoats also contain organic solvents, in the case of the solvent-based basecoats, and water and optionally, portions of organic, preferably water-miscible solvents, in the case of the water-based basecoats. The organic solvents are conventional paint solvents. These can originate from the production of the binders or are added separately. Examples of suitable solvents are mono- or polyhydric alcohols, for example, propanol, butanol, hexanol; glycol ethers or esters, for example, diethyleneglycoldialkylether, dipropyleneglycoldialkylether, each with C₁ to C₆ alkyl, ethoxypropanol, butylglycol; glycols, for example, ethyeleneglycol, propyleneglycol, N-methylpyrrolidone and ketones, for example, methylethyl ketone, acetone, cyclohexanone; aromatic or aliphatic hydrocarbons, for example, toluene, xylene or linear or branched aliphatic C₆ to C₁₂ hydrocarbons.

According to the invention, solvent-based colour- and/or special-effect-imparting basecoats are applied in step A) to substrates precoated with conventional primers and/or fillers and/or further coating compositions. Examples of substrates here are metal and plastics substrates, in particular the substrates known in the automotive industry, such as, iron, zinc, aluminum, magnesium or the alloys thereof, and polyurethanes, polycarbonates or polyolefins. These substrates are precoated in the conventional manner. The primers and/or fillers can be conventional coating compounds of the type used as filler and/or primer by the person skilled in the art in vehicle painting. For example, these can be primer and/or filler layers applied in the course of refinishing, with binder systems based on, for example, physically drying binders, such as, physically drying polyurethane and/or polyacrylate resins, and chemically cross-linking binders, such as, epoxy resins and polyamine curing agents or hydroxyfunctional resins and polyisocyanate cross-linking agents. The primers and/or fillers used can be solvent-based or water-based. The basecoats can, however, also be applied to intact old finishes (original or refinishing paints) or to primed new parts, for example, primed plastics parts. The solvent-based basecoats are applied in dry layer thicknesses of about 15 to 55 μm to the prior coating. After an evaporation phase a water-based base coat can then be applied directly wet-on-wet in accordance with step B). The water-based base coat can, however, also be applied after drying or curing of the solvent-based basecoat, for example, at ambient temperature or forced at elevated temperatures, for example up to 80° C., preferably, at 40 to 60° C. The water-based basecoats are applied in dry layer thicknesses of about 15 to 35 μm.

Both the solvent-based and the water-based paints can be formulated as one-component or two-component coating compositions. It is also possible here to add, for example, polyisocyanates to the basecoats without hydroxyfunctional binders being present.

The water-based paints applied in step B) can be dried or cured after application. This can take place, for example, at ambient temperature or forced at elevated temperatures, for example, up to 80° C., preferably, at 40 to 60° C. However, the paints can also be dried or cured at elevated temperatures of, for example, 80 to 150° C.

The water-based paints applied are then coated with clear lacquers. In the process, the clear lacquers can either be applied after drying or curing of the basecoat layer or wet-on-wet, optionally, after an evaporation phase, to the water-based paint coat. The clear lacquers are preferably applied wet-on-wet to the water-based paint coat. The evaporation phase can, for example, be 15 to 45 minutes, as a function of the relative air humidity.

In principle, any known non-pigmented or transparent pigmented coating compounds, as are conventional, for example, in vehicle painting, are suitable as clear lacquers. These can be clear solvent- or water-based lacquers. In particular, they are two-component clear lacquers based on chemically cross-linking binders, for example, based on hydroxyfunctional binder components and polyisocyanate cross-linking agents. The clear lacquers can be cured as described above for curing of the basecoat. For example, curing can take place at ambient temperature over several hours or forced at temperatures of, for example, 40 to 60° C., for example, within 30 to 80 minutes. Curing can also take place or be assisted by means of IR or NIR radiation. When using binders which can be cured by means of high-energy radiation, curing can also take place by means of UV radiation. Drying/curing of basecoat and clear lacquer takes place in a common step in the preferred wet-on-wet application of the clear lacquer.

In principle, the method according to the invention can, as an alternative, also take place in accordance with the above-mentioned method in that firstly, a water-based and then a solvent-based basecoat are applied. The details given above on drying and curing apply accordingly. However, the operation is preferably such that firstly a solvent-based basecoat, in particular, preferably a two-component solvent-based basecoat, for example, based on hydroxyfunctional binders and polyisocyanate curing agents, and then a water-based paint are applied.

The process according to the invention can advantageously be used where thick layers are required or unavoidable in the application of water-based paints. An example of an advantageous application is the three-layer structure with coloured solid-color basecoat as background shade, special-effect basecoat and clear coat. The solid-color basecoat contains colour-imparting covering absorption pigments (coloured pigments) which are matched to the shade of the special-effect basecoat. The special-effect basecoat contains non-covering transparent special-effect pigments, for example, interference pigments, such as, metal oxide-coated metal pigments, for example titanium dioxide-coated, iron oxide-coated or mixed oxide-coated aluminum, coated mica, such as, titanium dioxide-coated mica and/or mica coated with further metal oxides, for example, Fe₂O₃ and/or Cr₂O₃. However, the method can also advantageously be used when the special-effect basecoat contains metallic pigments with poor covering capacity. In both cases, prepainting of a coloured, covering background paint coat is required. In the process the coloured solid-color basecoat or the special-effect basecoat can, according to the invention, be formulated as a water-based paint. The special-effect basecoat is, however, particularly preferably formulated as a water-based paint. The method according to the invention can also be effectively used when colour-imparting pigments with inferior coverage are used and which require an application in a plurality of spraying operations in order to achieve the required hiding power. In this case a solid-color water-based paint pigmented with colour-imparting pigments is over-painted with a solvent-based solid-color basecoat pigmented with colour-imparting pigments or preferably a solvent-based solid-color basecoat pigmented with colour-imparting pigments is over-painted with a solid-color water-based paint pigmented with colour-imparting pigment. The method according to the invention can also advantageously be used in multi-colour design painting in which various shades are applied to an object and high layer thicknesses of up to 80 μm can be achieved in particular in the overlapping regions.

The method according to the invention results in advantageous coatings with respect to the overall structure, compared with the methods known from the prior art for applying water-based basecoats. Water-based basecoats can be used to reduce solvent emission, and may be over-painted with solvent-based basecoats without problems, for example without wetting defects, or can be applied to solvent-based basecoats without problems. Satisfactory adhesion to the clear lacquer is achieved. The overall structure has good flow and gloss, in particular in the blending in region and a good final hardness and good masking capacity, i.e. no markings remain after masking the paint with masking tape and subsequently removing the masking tape.

The invention will be described in more detail by the following examples.

### EXAMPLES

### Example 1

### Application Example According to the Invention

A commercially available solvent-based, two-component filler coating compound (isocyanate cross-linking) (Standox® 2 component non-stop filler primer, Standox® 2-component hardener) was applied in a dry film layer thickness of about 60 μm to an electrophoretically coated mudguard cured for 30 minutes at 60° C. and then sanded. A commercially available yellow solvent-based solid-color basecoat (Standox® basecoat Audi base shade LY2D-golden yellow+Standox® 2-component MS hardener 15-30 +Standox® thinner MSB 15-25) was applied in a dry film layer thickness of a total of about 55 μm by means of spray guns to the filler layer thus obtained.

After an evaporation time of about 45 minutes, a commercially available pearl water-based paint (Standohyd® basecoat Audi L0D2 -Inca yellow Perlmutt Metallic) was then applied in a resultant dry layer thickness of about 15 μm to the basecoat layer thus obtained.

After an evaporation time of about 20 minutes, a two-component solvent-based clear coat (isocyanate cross-linking) (Standocryl® 2 component HS clear coat, Standox® 2 component HS hardener 20-30) was applied. After an evaporation time of 10 minutes, the composition was cured for 30 minutes at 60° C.

### Example 2

### Comparison Example

The method was carried out as in Example 1 but instead of the solvent-based solid-color basecoat used therein a corresponding solid-color water-based basecoat of the same shade (Standohyd® basecoat Audi base shade LY2D-golden yellow) was applied. After an evaporation time of 60 minutes, the method was then carried out as in Example 1.

The results of the two finishes are shown in the following table.

| | Example according to | Comparison |
|---|---|---|
| | the invention | example |
| Layer thickness | 70 μm | 70 μm |
| Top coat condition (1) (gloss | Good | satisfactory, |
| and flow) | | reduction in gloss |
| Masking capacity (2) | no marking | average marking |
| Hardness (3) | Good | satisfactory, |
| Fingernail test | | strong penetration |

(1) Visual assessment of flow and gloss
(2) After a final evaporation time, the paint coat was masked with 3M 471 masking tape. The masking tape was removed after 30 minutes and the visual assessment made.
(3) The hardness was tested using the fingernail test (penetration into the paint coat) after ageing for 17 hours at 50° C.

1. Method for multi-coat refinishing of substrates comprising the following steps:
A) applying a first coat of paint consisting of a solvent-based colour- and/or special-effect-imparting coating composition to a substrate precoated with a primer and/or a filler and/or further coating compositions,
B) applying a second paint coat consisting of a water-based colour- and/or special-effect-imparting coating composition to the layer obtained under A) and
C) applying a clear lacquer coat consisting of a transparent clear coat to the paint coat obtained under B).

2. Method for multi-coat refinishing of substrates comprising the following steps:
A) applying a first paint coat consisting of a water-based colour- and/or special-effect-imparting coating composition to a substrate precoated with a primer and/or a filler and/or further coating compositions,
B) applying a second paint coat consisting of a solvent-based colour- and/or special-effect-imparting coating composition to the layer obtained under A) and
C) applying a clear lacquer to the paint coat obtained under B).

3. Method according to claim 1, wherein the solvent-based colour- and/or special-effect-imparting coating composition is a solid-color basecoat pigmented with colour-imparting absorption pigments and the water-based colour- and/or special-effect-imparting coating composition is a water-based base coat pigmented with special-effect pigments.

4. Method according to claim 1, wherein the solvent-based colour- and/or special-effect-imparting coating composition is a solid-color two-component coating composition pigmented with colour-imparting absorption pigments.

5. Method according to claim 4, wherein the solid-color two-component coating composition contains polyisocyanates as cross-linking agents.

6. Method according to claim 1, wherein both the solvent-based colour- and/or special-effect-imparting coating composition and the water-based colour- and/or special-effect-imparting coating composition are solid-color basecoats pigmented with colour-imparting absorption pigments.

7. Method according to claim 2, wherein the water-based colour- and/or special-effect-imparting coating composition is a solid-color water-based basecoat pigmented with colour-imparting absorption pigments and the solvent-based colour- and/or special-effect-imparting coating composition is a solvent-based basecoat pigmented with special-effect pigments.

8. Method according to claim 2, wherein the solvent-based colour- and/or special-effect-imparting coating composition is a two-component coating composition pigmented with special-effect pigments.

9. Method according to claim 1, wherein the substrates are vehicles or vehicle components.

10. Method according to claim 2, wherein the substrates are vehicles or vehicle components.

11. A substrate coated according to the method of claim 1.
